(19) United States
(12) Patent Application Publication
(10) Pub. No.: US 2008/0053447 A1
(43) Pub. Date: Mar. 6, 2008

(54) Adapter for air purifying filter

(76) Inventors: John A. Ratajczak, Lancaster, NY (US); Christopher G. Estkowski, Pullman, MI (US)

Correspondence Address: HODGSON RUSS LLP;THE GUARANTY BUILDING, 140 PEARL STREET, SUITE 100, BUFFALO, NY, 14202-4040, US

(21) Appl. No.: 11/897,065

(22) Filed: Aug. 29, 2007

Related U.S. Application Data
(60) Provisional application No. 60/841,182, filed on Aug. 29, 2006.

(51) Int. Cl. A62B 18/02

(52) U.S. Cl. 128/205.25

(57) ABSTRACT

An adapter for use with a gas filter canister worn by a user as part of a breathing apparatus. The adapter is constructed of a semi-rigid plastic that has a plurality of scalloped or castellated edges. The scalloped or castellated edges allow the adapter to snap-fit over the top of the canister. Projections or lugs on the inside of the edge of the adapter can deflect and snap over the rim of the canister. An adapter seal in the form of a large preformed packing or O-ring, is pressed between the inside of the adapter top and the outside of the canister top such that an airtight seal is formed. The adapter is capable of moving relative to the filter canister to accommodate different positions of the flexible conduit between an adapter inlet and the outlet of a self contained blower assembly.

### CROSS-REFERENCE TO RELATED APPLICATION

This application claims the benefit of U.S. Provisional Patent Application No. 60/841,182 filed on Aug. 29, 2006, which is incorporated herein by reference.

### FIELD OF THE INVENTION

The present invention relates generally to a breathing apparatus for contaminated areas and specifically to an adapter for use with an air purifying filter.

### BACKGROUND OF THE INVENTION

For the protection of air crew members against breathing contaminated air in aircraft that do not supply oxygen to the air crew or when the air crew is not utilizing the oxygen supply, the crew members typically have a blower assembly, which takes in ambient air, strapped to their body. The blower assembly forces the air through a canister which purifies the air and delivers the air through a system of hoses to a facepiece worn by the crew member. In the event that the crew member exits the aircraft in a contaminated area, they would exit with the blower assembly connected to the canister and the canister connected to their facepiece.

Typically, this type of arrangement in the past required placing the canister inside a bulky housing or encapsulating it in an elastomeric boot which may restrict flow through the system. Also, when climbing out of the aircraft and walking away from the aircraft, the objects strapped to the body tend to shift resulting in pulling and tugging of the parts. This pulling and tugging can lead to partial crimping of the hoses and a resulting reduction in airflow through the canister.

What is needed is a device that closely follows the profile of the user such that the hose from the blower to the inlet of the canister can approach the canister at right angles instead of axially, such that relative motion between the blower and the canister can be accommodated by swivelling action of an adapter on the canister, and such that the device does not restrict flow.

### SUMMARY OF THE INVENTION

The present invention meets the above-described need by providing an adapter for use with a gas filter canister. The adapter is constructed of a semi-rigid plastic that has a plurality of scalloped or castellated edges. The scalloped or castellated edges allow the adapter to snap-fit over the top of the canister. Projections or lugs on the inside of the edge of the adapter can deflect and snap over the rim of the canister. An adapter seal in the form of a large preformed packing or O-ring, is pressed between the inside of the adapter top and the outside of the canister top such that an airtight seal is formed. Also, the seal provides sufficient friction to allow the adapter to swivel on the top of the canister.

### BRIEF DESCRIPTION OF THE DRAWINGS

The invention is illustrated in the drawings in which like reference characters designate the same or similar parts throughout the figures of which:

FIG. 1 is a perspective view of the adapter of the present invention attached to a filter canister;

FIG. 2 is a top plan view of the adapter;

FIG. 3 is a side elevational view of the adapter of the present invention attached to a filter canister;

FIG. 4 is a cross-sectional view taken along lines 4-4 of FIG. 3;

FIG. 5 is an enlarged detail view of a portion of FIG. 4; and,

FIG. 6 is a perspective view showing an adapter of the present invention installed on a canister strapped to the body of an aircraft crew member.

### DETAILED DESCRIPTION OF THE INVENTION

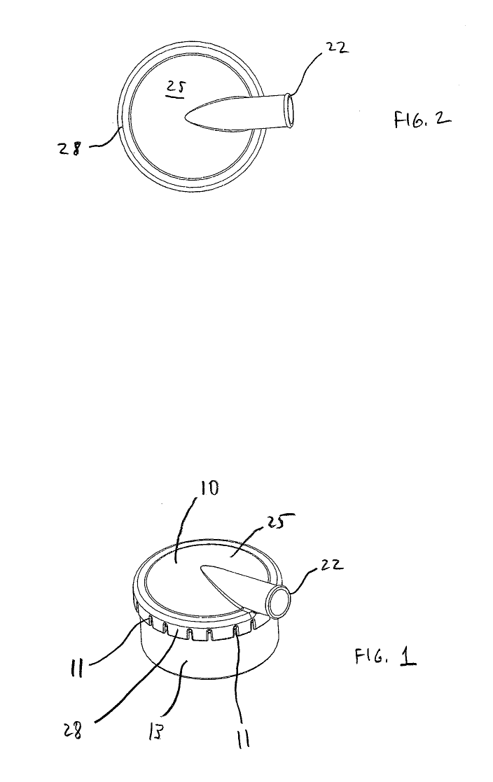

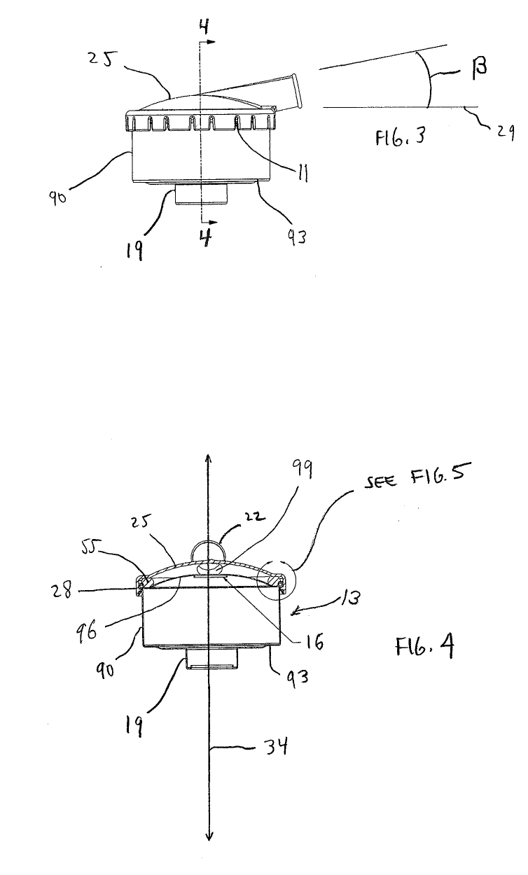

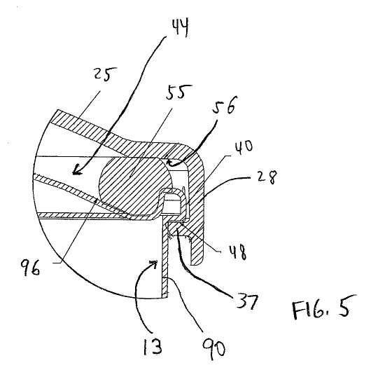

Referring to FIGS. 1-6 and initially to FIG. 1, an adapter 10 is attached to a filter canister 13. The adapter 10 can be sized to fit any standard gas mask canister with a bead or rim on the inlet end and that does not have a fitting at the inlet. If the canister is circular the adapter 10 will swivel as described below. The canister 13 may be a standard military C2A1 model with an opening 16 (shown in FIG. 4) at the top that receives ambient air and has no fitting. An outlet 19 (FIGS. 3-4) is positioned at the bottom of the canister 13. The outlet 19 may be equipped with a screw threaded fitting 100 (FIG. 6) that may be equipped with a ninety degree elbow as will be described below.

The adapter 10 may be provided with a plurality of channels 11 around the periphery of the device forming a plurality of scalloped or castellated edges. The adapter 10 includes an inlet 22, a top wall 25, and a side wall 28. The side wall 28 extends for a relatively short distance in a direction substantially perpendicular to the top wall 25. The side wall 28 has channels 11. The shape and the number of the channels 11 combine with the properties of the materials of construction for the adapter 10 to provide flexibility for fitting the adapter 10 over the canister 13 as will be described in detail below. The adapter 10 may be constructed from DuPont Zytel 80G14A NC010A. This material is a 14% glass filled, toughened, high flow polyamide 66 resin. The glass fiber reinforcement provides increased modulus to allow a snug snap fit of the adapter 10 onto the canister 13 and strength to resist breakage during assembly. The toughening provides good impact properties, and the high flow property of the material improves mold fill thereby reducing the appearance of knit line weakness in the adapter during molding. Other plastic and composite materials that are semi-rigid may also be suitable.

The inlet 22 is disposed at an angle β with respect to a horizontal axis 29 as best shown in FIG. 3. The angle β is determined by a number of factors including providing a low profile for the unit that does not interfere with the seal over the bead or rim 40 on the canister 13 and providing flow at or near the center of the canister 13. The canister 13 has a side wall 90, a bottom wall 93, and a lid 96 (FIG. 4).

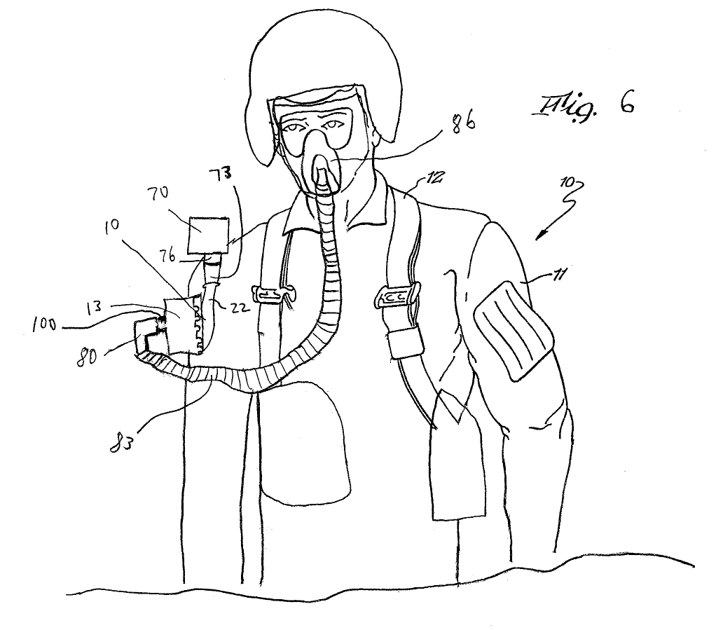

Turning to FIG. 4, the canister 13 has an inlet 16 that is disposed along a central longitudinal axis 34 of the canister 13. The outlet 19 of the canister 13 is also disposed along the longitudinal axis 34. The outlet 19 may be provided with a screw threaded fitting as described below. The adapter 10 has a plurality of lugs 37 (FIG. 5) that snap fit over the rim 40 of the canister 13. As best shown in FIG. 5, the lugs 37 are disposed substantially perpendicular to the side wall 28.

As shown in FIG. 5, the canister 13 has a lid 96 that extends to the rim 40. The rim 40 is disposed around the periphery of the canister 13 and forms a shoulder 48 that extends to the side wall 90 of the canister 13.

As best shown in FIGS. 4-5, the adapter 10 creates a plenum chamber 44 between the top wall 43 of the filter canister assembly and the inside surface of the adapter 10.

An O-ring type seal 55 may be disposed around the periphery of the canister 13 as best shown in FIG. 5. The O-ring seal 55 is oversized such that when the adapter 10 is snap fit onto the canister 13 the seal is compressed between the lid 96 of the canister 13, the top wall 25 of the adapter 10 and the rim 40 on the end of the canister 13, to form a substantially airtight seal. The gas seal 55 may be constructed from EPDM foam rubber material. The durometer may be approximately 50 Shore A with a tensile of 1500 psi and a stretch limit of 200%. EPDM is highly resistant to the types of chemical agents that the C21A filter protects against. The O-ring type seal 55 is designed oversize to bias the seal 55 to the inside of the rim 40 of the canister 13 and maintain force away from the center of the filter canister 13 to ensure the seal 55 stays in position. The seal 55 may be provided with a ⅜ of an inch diameter. A larger diameter seal can take the increased radial seal compression before buckling. As the seal 55 is compressed it has to be sufficiently large in diameter and of the proper material to resist the force being applied by the filter inside rim 40 and the adapter 10 to maintain proper position and compression. As a result of the oversize seal condition, the seal 55 can be pre-installed in the adapter 10, providing the user the ability to install the adapter 10 directly on the filter 13 without taking the time to pre-align the filter canister 13/adapter seal 55.

The plenum chamber 44 created between the filter canister assembly lid 96 and the inside surface of the adapter 10 reduces the effects of flow directional change on resistance. To further reduce resistance from turbulent flow the adapter inlet opening 99 (FIG. 4) is centered over the canister inlet 16 so airflow is directed into the filter inlet orifice 16.

The adapter seal 55 may be adjusted to provide for resistance that allows the adapter 10 to swivel on the top of the canister 13. The adapter 10 rotational resistance is controlled by the material type of the adapter seal 55 and the amount of preloaded force applied to the seal 55 resulting from the geometry of the adapter inner seal surface 56 in relation to the lug engagement face or shoulder 48. Adjusting this distance can vary the resistance required to rotate the adapter 10 to the desired position and varies based on the seal material type. This characteristic allows the adapter 10 to be rotated into a desired position by hand yet maintain this position during use. The adapter 10 installation force is controlled by the plurality and the geometry of the lugs 37 used to engage the filter rim 40. There may be ten or more lugs 37 but as few as two lugs 37 can be used to break the hoop strength of the adapter rim cylindrical engagement wall and allow the wall to flex outward while the lug 37 negotiates around the rim 40 of the filter canister 13. Once past the filter rim 40 the lug 37 maintains sufficient force against the filter body wall 90 to ensure the adapter 10 is secured to the filter canister 13 by using the remaining hoop strength characteristic in a curved surface bending perpendicular to the radius and the engineering properties of the material used in the construction of the adapter 10. These properties provide the modulus, tensile and flexural strength required by the application.

Turning to FIG. 6, the adapter 10 of the present invention is shown in use with a canister 13 and a blower assembly 70 that are strapped to the body of an aircraft crew member. As shown, the blower assembly 70 is mounted to the shoulder of the aircraft crew member. A hose 73 extends from the outlet 76 of the blower assembly 70 toward the inlet to the adapter 10. The hose 73 from the blower assembly 70 attaches to the inlet 22 of the adapter 10 at a position that is approximately 90 degrees to the inlet 16 of the filter canister 13. The adapter 10 and the adapter inlet 22 are capable of rotating relative to the filter canister 13 so that movements of the body of the crew member can be accommodated without crimping the hoses.

At the outlet of the canister 13 a fitting 100 may be provided with a ninety degree elbow 80 that connects to a hose 83. The hose 83 runs to the facepiece 86 to provide breathable air to the user. Accordingly, the blower assembly 70 takes in ambient air which is then forced through the canister 13 and conveyed to the facepiece 86 of the user to provide breathable air in contaminated areas.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. An adapter for use with a filter canister, the filter canister having a rim on the inlet end, the adapter comprising:
a top wall;
a side wall connected to the top wall;
at least one lug extending from the side wall, the lug sized to frictionally fit over the rim of the filter canister when the adapter is joined with the filter canister;
at least one seal disposed between the adapter and the filter canister when they are joined together;
an adapter inlet extending from the top wall; and
wherein the adapter is capable of moving relative to the filter canister when the adapter is joined with the filter canister.

2. The adapter of claim 1, wherein the side wall has at least one opening defined therein.

3. The adapter of claim 2, wherein the at least one opening comprises a plurality of U-shaped openings forming a scalloped bottom edge of the side wall.

4. The adapter of claim 1, wherein the at least one lug comprises a plurality of lugs.

5. The adapter of claim 1, wherein the at least one lug extends substantially perpendicular to the side wall.

6. The adapter of claim 1, wherein the at least one seal is an O-ring.

7. The adapter of claim 1, wherein the O-ring is larger than a space between the top wall of the adapter and the filter canister, the space being created when the adapter is joined to the filter canister, the size differential between the space and the O-ring causing the O-ring to be compressed when the adapter is joined with the filter canister.

8. The adapter of claim 1, wherein the adapter inlet is disposed at an angle relative to the canister.

9. The adapter of claim 1, wherein the adapter is round.

10. The adapter of claim 9, wherein the adapter is capable of rotating relative to the filter canister.

11. A breathing apparatus for mounting on the body of a user, the breathing apparatus, comprising:
a filter canister having a rim on the inlet end and having an outlet;
an adapter having a top wall, a side wall connected to the top wall, the side wall having at least one lug sized to frictionally fit over the rim of the filter canister, the adapter having at least one seal disposed between the adapter and the filter canister when the adapter is joined to the filter canister, the adapter having an inlet;
a self-contained blower assembly disposed in fluid communication with the adapter inlet;
a breathing mask in fluid communication with the outlet of the filter canister;
wherein the adapter is capable of moving relative to the filter canister when the adapter is joined with the adapter.

12. The apparatus of claim 11, wherein the side wall has at least one opening defined therein.

13. The apparatus of claim 12, wherein the at least one opening comprises a plurality of U-shaped openings extending to a bottom edge of the side wall.

14. The apparatus of claim 11, wherein the at least one lug comprises a plurality of lugs.

15. The apparatus of claim 11, wherein the at least one lug extends substantially perpendicular to the side wall.

16. The apparatus of claim 11, wherein the at least one seal is an O-ring.

17. The apparatus of claim 11, wherein the O-ring is larger than a space between the top wall of the adapter and the filter canister such that the O-ring is compressed when the adapter is joined with the filter canister.

18. The apparatus of claim 11, wherein the adapter inlet is disposed at an angle relative to the canister.

19. The apparatus of claim 11, wherein the filter canister is a C2A1 model.

20. The apparatus of claim 11, wherein the blower assembly is mounted to the shoulder of the user.

21. The apparatus of claim 11, wherein the filter canister and adapter are joined together and supported on the arm of the user.

22. The apparatus of claim 11, further comprising a first flexible conduit disposed between the self-contained blower assembly and the inlet to the adapter.

23. The apparatus of claim 11, further comprising a second flexible conduit disposed between the outlet of the filter canister and the breathing mask.

24. The apparatus of claim 22, wherein the movement of the adapter relative to the filter canister accommodates different positions of the first flexible conduit resulting from movement of the user.

25. A breathing apparatus for mounting on the body of a user, the breathing apparatus, comprising:
a filter canister having an inlet, a rim on the inlet end, and having an outlet;
an adapter having a top wall, a side wall connected to the top wall, the side wall having at least one lug extending therefrom, the lug sized to frictionally fit over the rim of the filter canister to join the adapter to the canister, the adapter having at least one seal disposed between the adapter and the canister when the adapter is joined to the canister, the adapter having an inlet, the adapter being capable of moving relative to the filter canister when the adapter is joined to the canister;
a self-contained blower assembly disposed in fluid communication with the adapter inlet;
a first flexible breathing conduit disposed between the blower assembly and the adapter inlet;
a breathing mask in fluid communication with the outlet of the filter canister such that filter air is conveyed to the user;
wherein the movement of the adapter relative to the filter canister accommodates different positions of the first flexible conduit resulting from movement of the user.

26. The apparatus of claim 25, wherein the adapter inlet is elongate with a first end and a second end centered over the filter canister inlet.
